(19) United States
(12) Patent Application Publication
(10) Pub. No.: US 2009/0107027 A1
(43) Pub. Date: Apr. 30, 2009

(54) Flat top fishing lure

(76) Inventor: David Partridge, Defuniak Sps., FL (US)

Correspondence Address: John Wiley Horton, Attorney;Pennington, Moore, Wilkinson, Bell & Dunbar, P.A., 2nd Floor, 215 S. Monroe St., Tallahassee, FL, 32301, US

(21) Appl. No.: 12/290,567

(22) Filed: Oct. 31, 2008

Related U.S. Application Data
(60) Provisional application No. 61/001,162, filed on Oct. 31, 2007.

(51) Int. Cl. A01K 85/00

(52) U.S. Cl. 43/42.19; 43/42; 43/42.32

(57) ABSTRACT

A surface lure designed to mimic the appearance of an injured fish. The surface lure has a flat top surface which helps maintain the lure in a proper orientation in the water when reeled in. The surface lure also has a contoured bottom surface which is designed to mimic the appearance of a fish floating on its side when viewed from below the lure. The flat top surface may be painted a visually distinctive color so that the fisherman can easily spot the lure in the water.

### BACKGROUND OF THE INVENTION

1. Field of the Invention

This invention relates to the field of fishing lures. More specifically, the present invention comprises a fishing lure designed to mimic an injured or dead fish.

2. Description of the Related Art

Many fishing lures have been created for enticing a fish to bite a hook on a fishing line. Those that are skilled in the art know that different lures work better for different conditions. Generally, there remains a need for new, effective lures that increase a fisherman's chances of getting a strike.

Fishing lures come in many different varieties. Some lures are designed to float at the surface of the water. These lures are generally known as “surface lures” and are commonly used when fishing for bass, cod, or bream. One problem with using surface lures is that the lure often entices other creatures, such as birds and turtles, to strike the lure. Thus it would also be desirable to provide a new, effective surface lure which is less likely to entice birds and turtles to strike the lure.

### BRIEF SUMMARY OF THE INVENTION

The present invention is a surface lure designed to mimic the appearance of an injured fish. The surface lure has a flat top surface which helps maintain the lure in a proper orientation in the water when reeled in. The surface lure also has a contoured bottom surface which is designed to mimic the appearance of a fish floating on its side when viewed from below the lure. The flat top surface may be painted a visually distinctive color so that the fisherman can easily spot the lure in the water.

### BRIEF DESCRIPTION OF THE SEVERAL VIEWS OF THE DRAWINGS

FIG. 1 is a perspective view, showing the present invention.

FIG. 2 is a perspective view, looking upward at the present invention.

FIG. 3 is a side view, showing the present invention.

FIG. 4 is a bottom view, showing the present invention.

FIG. 5 is a side view, showing the present invention.

### REFERENCE NUMERALS IN THE DRAWINGS

| | | | |
|---|---|---|---|
| 10 | surface lure | 12 | flat surface |
| 14 | contoured surface | 16 | eye |
| 18 | fastener | 20 | treble hook |
| 22 | treble hook | 24 | fastener |
| 26 | impeller | 28 | contoured surface |
| 30 | fin | 32 | design |
| 34 | treble hook | 36 | treble hook |
| 38 | flat surface | 40 | loop |
| 42 | threads | 44 | loop |
| 46 | edge | 48 | central axis |

### DETAILED DESCRIPTION OF THE INVENTION

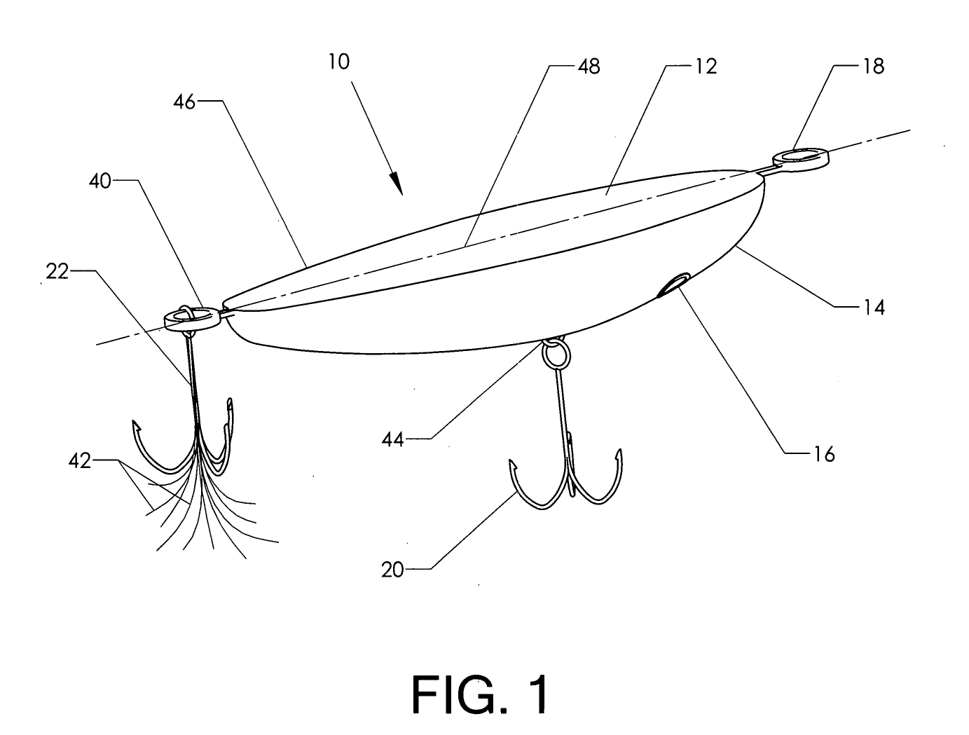

The present invention, surface lure 10 is illustrated in FIG. 1. Surface lure 10 has flat surface 12 and contoured surface 14. Flat surface 12 faces upward and is approximately level with the surface of the water when surface lure 10 is cast into the water. Thus, contoured surface 14 is submerged in the water and is visible to fish under and around surface lure 10. Flat surface 12 is an oval shape having at least one central axis 48 shown in FIG. 1 by the broken line. Contoured surface 14 and flat surface 12 meet at edge 46 which follows the oval shape of flat surface 12.

Fastener 18 is provided on one end of surface lure 10 at edge 46 for fastening surface lure 10 to a fishing line. Treble hooks 20 and 22 are provided on the medial portion and end of surface lure 10 opposite fastener 18, respectively. Treble hooks 20 and 22 can be connected to surface lure 10 by any means known in the prior art. In the present embodiment loop 40 is attached to edge 46 opposite fastener and loop 44 is attached proximate the center of contoured surface 14. Treble hook 20 attaches to loop 44 and treble hook 22 attaches to loop 40. Treble hook 22 preferably contains a plurality of threads 42 which help to attract fish. While treble hooks 22 and 20 are used in this design, one skilled in the art should recognize that any type of fishing hook can be utilized in place of the treble hooks.

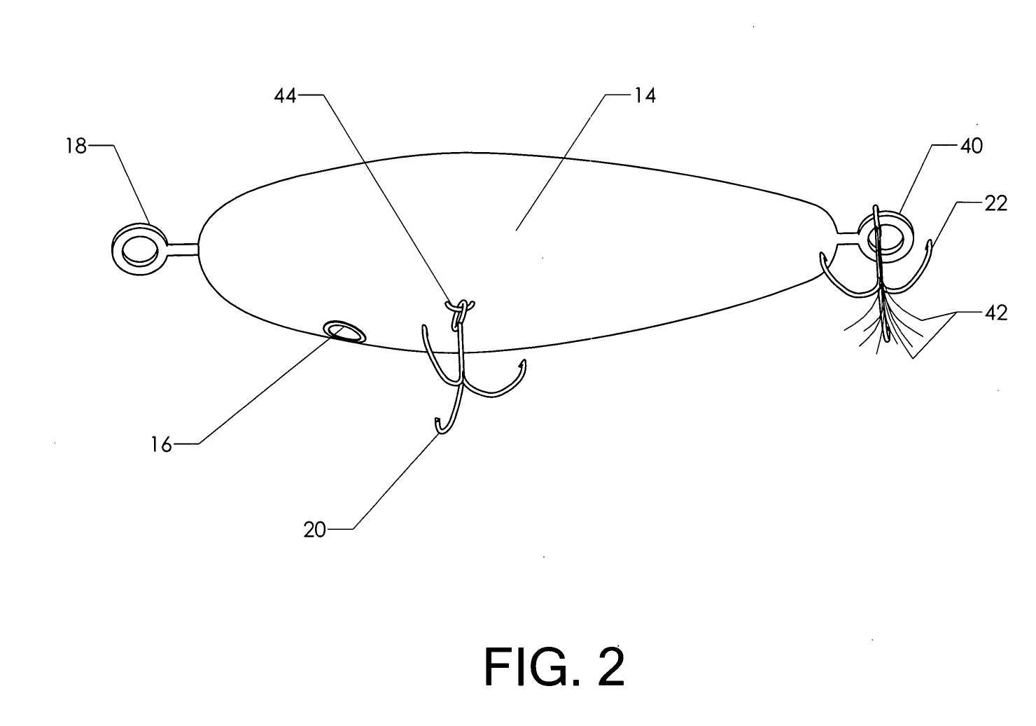

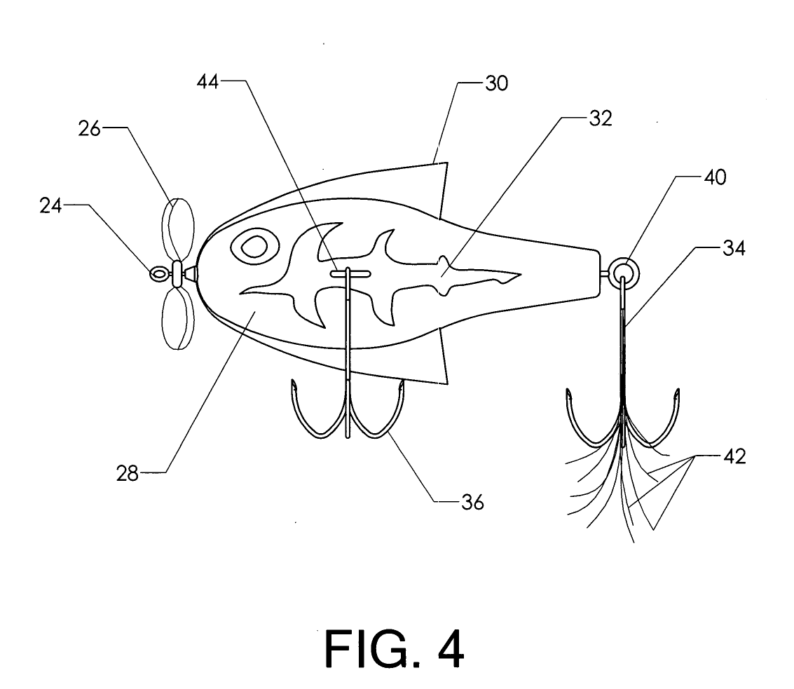

FIG. 2 shows the same lure looking upward from an angle beneath the surface lure 10. The reader will note that contoured surface 14 is generally designed to mimic the appearance of a small fish (such as a minnow) that is floating on its side. This is particularly enticing to a fish because the lure mimics the appearance of an injured fish. When feeding, many species of fish target other injured fish. This is most likely because an injured fish appears to be easy prey. As mentioned previously, contoured surface 14 faces down when surface lure 10 floats on the surface of the water. Thus, contoured surface 14 and eye 16 are visible to fish that are swimming around surface lure 10. Other features, such as fins 30 and designs 32 described and illustrated in FIG. 4, can be added to downward facing contoured surface 14 to give the surface lure 10 a more lifelike portrayal of a fish.

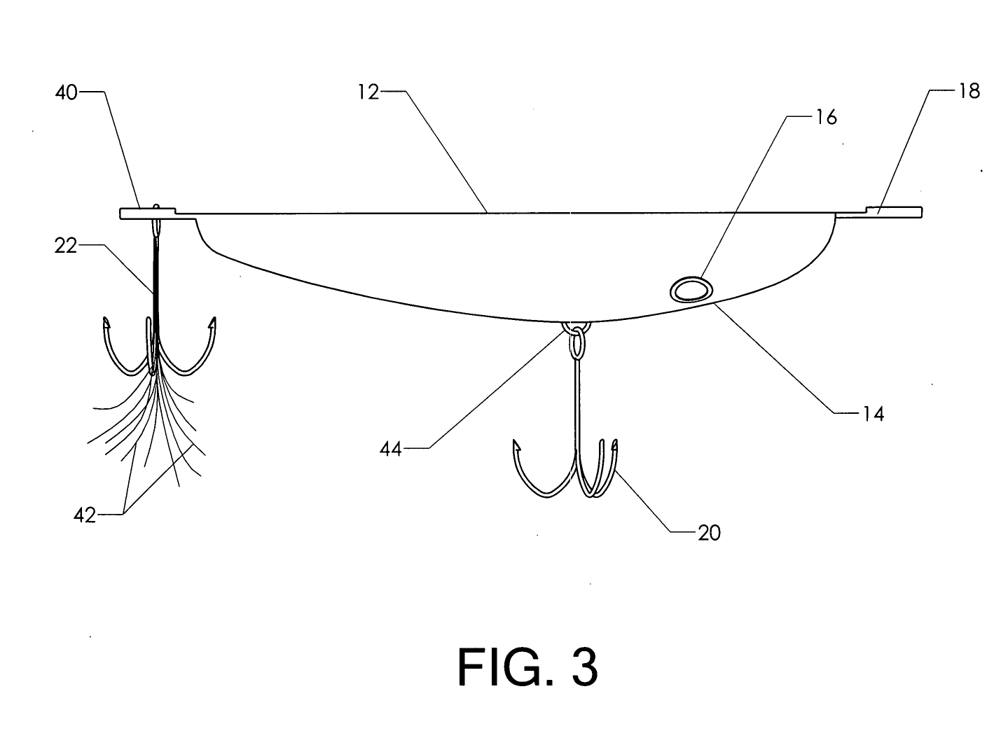

A side profile of fishing lure 10 is illustrated in FIG. 3. Flat surface 12 helps maintain fishing lure 10 in the desired orientation when passively floating and when being reeled in to the fisherman. Flat surface 12 acts to resist the rotation of surface lure 10 about its longitudinal axis (the axis extending between fastener 18 and the fastener of treble hook 22). Because surface lure 10 will not rotate, flat surface 12 will not be visible to the fish. As such, flat surface 12 need not resemble the appearance of a fish. In fact, it is preferable that flat surface 12 does not mimic the appearance of a fish from above the water. This reduces the likelihood that fishing lure 10 will be stricken by a bird or turtle.

In addition, flat surface 12 may be painted a distinctive color (such as orange) to make surface lure 10 more visible to the fisherman when surface lure 10 is floating in the water. Flat surface 12 may also be colored with fluorescent or other coloring which would make flat surface 12 visible to the fisherman when fishing at night or in low light conditions. This would allow the fisherman to detect more easily when a fish strikes the lure.

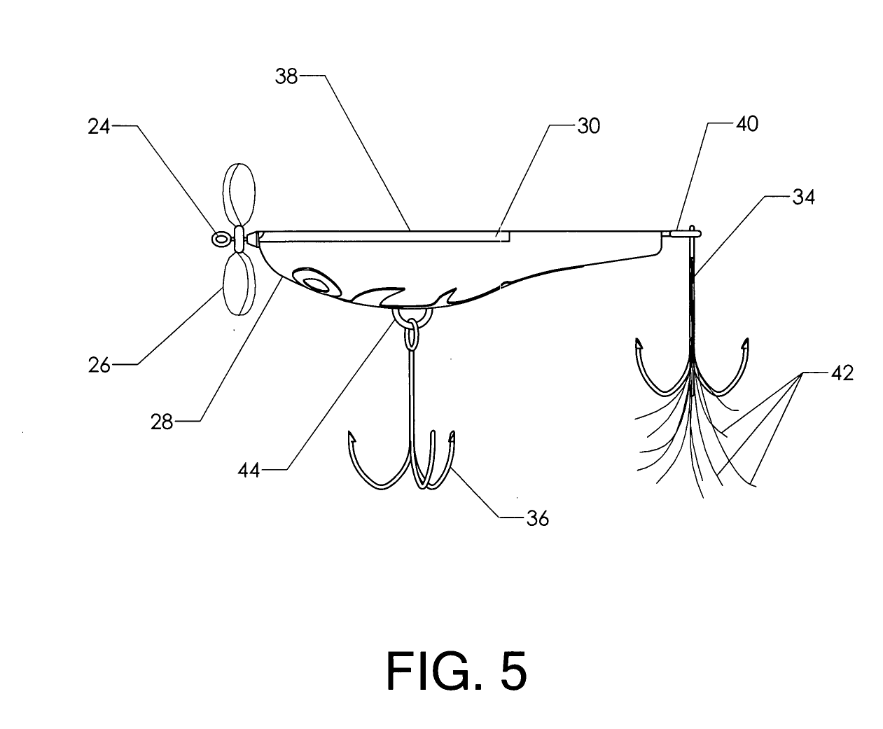

As shown in FIGS. 4 and 5, many different design elements may be incorporated into surface lure 10 to increase its attractiveness to fish. FIG. 4 shows contoured surface 28. Design 32 and fins 30 may be provided to contoured surface 28 to mimic the appearance of different species of fish. In addition, traditional elements used to influence the behavior or reflectivity of surface lures such as propeller 26 (attached to fastener 24) may be attached to the lure. Also, treble hooks 36 and 34 may be attached at other locations on contoured surface 28. As shown in FIG. 5, the lure design illustrated in FIG. 4 also has flat surface 38 in order to maintain the lure in the designed orientation when floating and when being reeled in to the fisherman.

The preceding description contains significant detail regarding the novel aspects of the present invention. It should not be construed, however, as limiting the scope of the invention but rather as providing illustrations of the preferred embodiments of the invention. Thus, the scope of the invention should be fixed by the following claims, rather than by the examples given.

1. A lure for use with a fishing line in a body of water, said body of water having a surface, wherein said lure is designed to float along said surface of said body of water, comprising:
a. a top portion:
i. wherein said top portion is a flat surface, having a forward end;
ii. wherein said flat surface is an oval shape having a length and a width; and
iii. wherein said top portion has a circumference and a center;
b. a bottom portion:
i. wherein said bottom portion is a contoured surface, protruding downward from said flat surface;
ii. wherein said bottom portion meets said top portion along an edge at said circumference of said top portion; and
iii. wherein said bottom portion has a circumference and a center;
c. a hook attached to said lure; and
d. a fastener attached to said lure proximate said forward end of said top surface, said fastener being configured to attach said lure to a fishing line so that said lure can move along said surface of said body of water with said top portion facing upward and said bottom portion facing downward into said body of water.

2. A lure as recited in claim 1, wherein said hook is attached to said contoured surface at said center of said bottom portion.

3. A lure as recited in claim 2, further comprising a second hook attached to said edge at said circumference of said top portion.

4. A lure as recited in claim 1, wherein said hook is attached to said edge at said circumference of said top portion.

5. A lure as recited in claim 1, wherein said oval shape has a central axis along said length.

6. A lure as recited in claim 5, further comprising a first fin attached to said edge of said lure parallel to said central axis.

7. A lure as recited in claim 6, further comprising a second fin attached to said edge of said lure parallel to said central axis opposite said first fin.

8. A lure as recited in claim 1, wherein said flat surface of said top portion is a bright color.

9. A lure as recited in claim 1, wherein said contoured surface of said bottom portion is a design of a fish containing at least one eye.

10. A lure as recited in claim 2, further comprising a loop to attach said hook to said contoured surface.

11. A lure as recited in claim 3, further comprising a loop to attach said second hook to said edge.

12. A lure for use with a fishing line in a body of water, said body of water having a surface, wherein said lure is designed to float along said surface of said body of water, comprising:
a. a top portion:
i. wherein said top portion is a flat surface, having a forward end;
ii. wherein said flat surface is an oval shape having a length and a width;
iii. wherein said oval shape has a central axis along said length of said flat surface; and
iv. wherein said top portion has a circumference and a center;
b. a bottom portion:
i. wherein said bottom portion is a contoured surface, protruding downward from said flat surface;
ii. wherein said bottom portion meets said top portion along an edge; and
iii. wherein said bottom portion has a circumference and a center;
c. an edge formed where said circumference of said bottom portion meets said circumference of said top portion;
d. a hook attached to said lure;
e. an impeller attached to said lure proximate said forward end of said top surface along said central axis; and
f. a fastener attached to said impeller, said fastener being configured to attach said lure to a fishing line so that said lure can move along said surface of said body of water with said top portion facing upward and said bottom portion facing downward into said body of water.

13. A lure as recited in claim 12, wherein said hook is attached to said contoured surface at said center of said bottom portion.

14. A lure as recited in claim 13, further comprising a second hook attached to said edge at said circumference of said top portion.

15. A lure as recited in claim 12, further comprising a first fin attached to said edge of said lure parallel to said central axis of said lure.

16. A lure as recited in claim 15, further comprising a second fin attached to said edge of said lure parallel to said central axis of said lure opposite said first fin.

17. A lure as recited in claim 14, wherein said hook and said second hook are three-point treble hooks.

18. A lure as recited in claim 11, wherein said flat surface of said top portion is a bright color.

19. A lure as recited in claim 11, wherein said contoured surface of said bottom portion is a design of a fish containing at least one eye.

20. A lure as recited in claim 14, further comprising a first loop and a second loop:
a. wherein said first loop attaches said hook to said contoured surface; and
b. wherein said second loop attaches said second hook to said edge.
